(19) United States
(12) Patent Application Publication
(10) Pub. No.: US 2012/0235686 A1
(43) Pub. Date: Sep. 20, 2012

(54) Non-Magnetic Transmitter Housing

(75) Inventor: Steven W. Wentworth, Fountain Hills, AZ (US)

(73) Assignee: Earth Tool Company LLC, Oconomowoc, WI (US)

(21) Appl. No.: 13/481,115

(22) Filed: May 25, 2012

Related U.S. Application Data
(63) Continuation of application No. 12/653,282, filed on Dec. 10, 2009.
(60) Provisional application No. 61/201,394, filed on Dec. 10, 2008.

(51) Int. Cl. G01V 3/26

(52) U.S. Cl. 324/338

(57) ABSTRACT

A sonde assembly of the invention includes a sonde housing in the form of a nonmagnetic tube having windows therein for permitting a radio signal to be transmitted out the tube from the inside, means such as a device enclosing a front end of the tube, a sonde disposed inside the non-magnetic tube and closely fitting in a sonde cavity thereof in engagement with a front end plug. The sonde comprises a sensor and a transmitter connected to the sensor to transmit a directional signal based on sensor output, which sensor and transmitter are disposed inside a non-magnetic sonde cavity.

This application is a continuation of U.S. patent application Ser. No. 12/653,282, filed Dec. 10, 2009, which claims priority of U.S. provisional application Ser. No. 61/1201,394 filed Dec. 10, 2008, and the entire contents of each are incorporated herein by reference.

### FIELD OF THE INVENTION

The present invention relates to directional drilling systems, and more specifically to a sonde used to transmit information concerning a drill head used in directional drilling.

### SUMMARY OF THE INVENTION

The present invention is directed to a sonde assembly. The sonde assembly comprises a sonde housing comprising a non-magnetic tube, the tube forming a non-magnetic sonde cavity, a front plug for enclosing a front end opening of the non-magnetic sonde cavity, and a sonde slidingly disposed inside the non-magnetic sonde cavity. The sonde comprises a sensor and a radio transmitter connected to the sensor to transmit a directional sensor based on sensor input. The sonde assembly further comprises a rear end cap securable in a fixed position in a rear end opening of the non-magnetic sonde cavity. Upon securing the rear end cap in a rear end opening of the sonde housing, the sonde is secured in a fixed position relative to the sonde housing.

The present invention is also directed to a second embodiment of a sonde assembly. The sonde assembly comprises a sonde housing in the form of a non-magnetic tube, the tube forming a non-magnetic sonde cavity, a means for enclosing a front end opening of the non-magnetic tube, and a sonde slidingly disposed inside the non-magnetic sonde housing. The sonde comprises a sensor and a radio transmitter connected to the sensor to transmit a directional sensor based on sensor input. The sonde assembly further comprises a means for enclosing the rear end opening of the non-magnetic sonde housing. Upon securing the rear end opening of the non-magnetic sonde housing, the sonde is secured in a fixed position relative to the non-magnetic sonde housing.

The present invention is further directed to a third embodiment of the sonde assembly. The sonde assembly comprises a sonde housing in the form of a non-magnetic tube, a front plug for enclosing a front end opening of the non-magnetic tube, a sonde slidingly disposed inside the non-magnetic tube, and a rear end cap securable in a fixed position in a rear end opening of the non-magnetic tube.

### BRIEF DESCRIPTION OF THE DRAWINGS

FIG. 1 is a side view of a drill head having a sonde assembly of the invention.

FIG. 2 is a lengthwise sectional view of the drill head of FIG. 1 along the line 2-2 in FIG. 1.

FIG. 3 is an enlarged view of the circled area 3 in FIG. 2.

FIG. 4 is an enlarged view of the circled area 4 in FIG. 2.

FIG. 5 is an enlarged view of the circled area 5 in FIG. 4.

FIG. 6 is a partial side view of a sonde assembly of the invention.

FIG. 7 is an end view of the rear end cap of the sonde assembly of FIG. 6.

FIG. 8 is a top view of the sonde assembly of FIG. 6.

FIG. 9 is a side view partly in section, of the sonde assembly of FIG. 6.

FIG. 10 is an enlarged view of the circled area 10 in FIG. 9.

### DETAILED DESCRIPTION

Horizontal directional drilling (“HDD”) has become an effective and efficient method of installing or rehabilitating utilities with minimal surface disruption. However, accurate placement of utilities in HDD tends to require accurate tracking of a drill head as it progresses along a borepath. Thus, several methods of tracking have developed over time. One such method of tracking is called “walkover tracking”. Walkover tracking uses a wireless signal beacon disposed underground proximate or within the drill head and an above-ground tracker used to detect a signal transmitted from the beacon. The signal is used to determine the location and orientation of the drill head. Another method of tracking the drill head utilizes a wireline transmitter.

Wireline sondes (transmitters) are capable of reading the earth's magnetic field rather than gravity. These systems are capable of use underneath busy streets, rivers or other locations where a walkover transmitter may be imperiled by traffic, need for a boat, or the signal may be affected by the existence of steel rebar between the receiver and the transmitter. One potential drawback to the use of a wireline sonde is that they are generally required to be located at a distance (preferably at least about 10 feet) from any magnetic item, including alloy steel making up the housing or drill pipe. Steel alloys commonly used to make sonde housings are sufficiently magnetic to prevent the sonde from sensing the earth's magnetic field accurately. To remedy this, non-magnetic variations of stainless steel can be used.

Non-magnetic variations of stainless steel, however, can be difficult to fabricate into tooling because they have a low machinability rating. Thus, end load housings have been developed because of their simplicity of design. As used herein “end load housing” means the drill stem may be disconnected from the housing to access the sonde for loading/unloading through the end of the housing. End load housings normally restrain and clock the sonde relative to the housing with a slot in the sonde to engage a tabbed feature within the housing. The sonde is then trapped from the opposite end with a plug which maintains the tab/slot engagement and therefore the clock orientation of the sonde relative to the housing.

The action of finding and engaging the slot and the tab is risk prone as it cannot be inspected at the bottom of its blind bore, a bore possibly contaminated with dried mud. Should this engagement not be accomplished, the sonde will drift in clock position during operation and the drill head orientation signals from the sonde will be inaccurate. Inaccurate orientation readings may cause the drill head to deviate from the desired borepath.

Turning now to the Figures, and more specifically FIG. 1, there is shown therein a sonde assembly 100 of the present invention. The sonde assembly 100 is constructed, as described herein, to reduce the risk of not engaging a housing tab into the sonde slot by rigidly bolting the sonde to a plug which threadedly retains the sonde within the housing.

The sonde assembly 100 of FIG. 1 comprises a drill bit 12 and a sonde housing 14. The drill bit 12 may comprise a slant-faced steering bit. The slant-faced bit 12 may comprise a conventional flat bill made of non-magnetic steel. A plurality of bolts 15 are used to secure the bit 12 to the housing 14. The bit 12 is used to bore through the ground; it should be appreciated that a variety of drill bits could be used with the current invention including drag bits, rotary bits and back reamers.

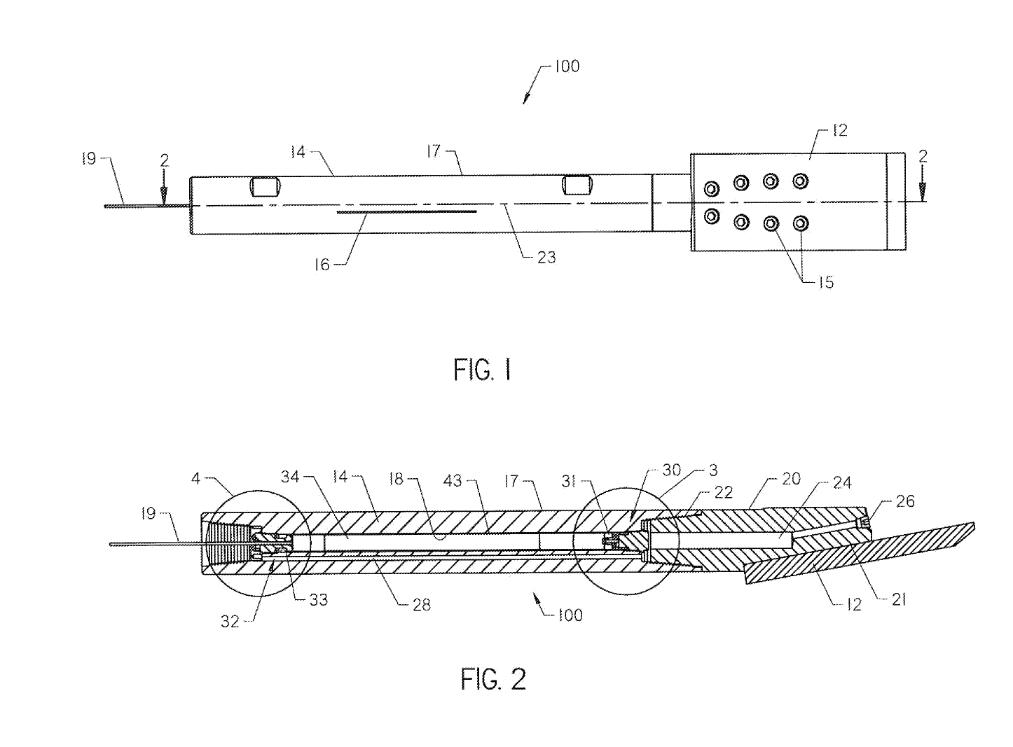

The sonde housing 14 comprises a non-magnetic housing 17 having a cavity 18 (FIG. 2). The cavity 18 is vented to the outside ground pressure through at least one window 16. Window 16 permits a directional signal to be transmitted from inside the non-magnetic housing 17. These windows 16 may be open, or they may be sealed with putty that will yield and leak should sufficient differential pressures develop between the cavity 18 and the adjacent soil.

Wireline 19 is shown extending from the up hole end of housing 17 and may extend to the surface along the drill string (not shown). As shown in FIG. 2, the wireline 19 is connected to the sonde 34 and passes through a yet to be described rear end plug 32.

Turning to FIG. 2, the sonde assembly 100 of FIG. 1 is shown in a longitudinal section view. The drill a bit adapter 20 is shown supporting dill bit 12 and connected to housing 17. The bit adapter 20 is used to support the drill bit 12 relative to the housing. The bit adaptor 20 shown in FIG. 2 comprises an angled face 21 for mounting the bit at an angle relative to a central axis 23 (FIG. 1) of the housing 17 to facilitate steering. One skilled in the art will appreciate that the bit adaptor 20 may comprise a threaded portion (not shown) at its downhole end to facilitate the connection of a rotary bit or backreamer to the housing 17. Alternatively, the bit adaptor 20 may have a drill bit 12 formed integrally therewith.

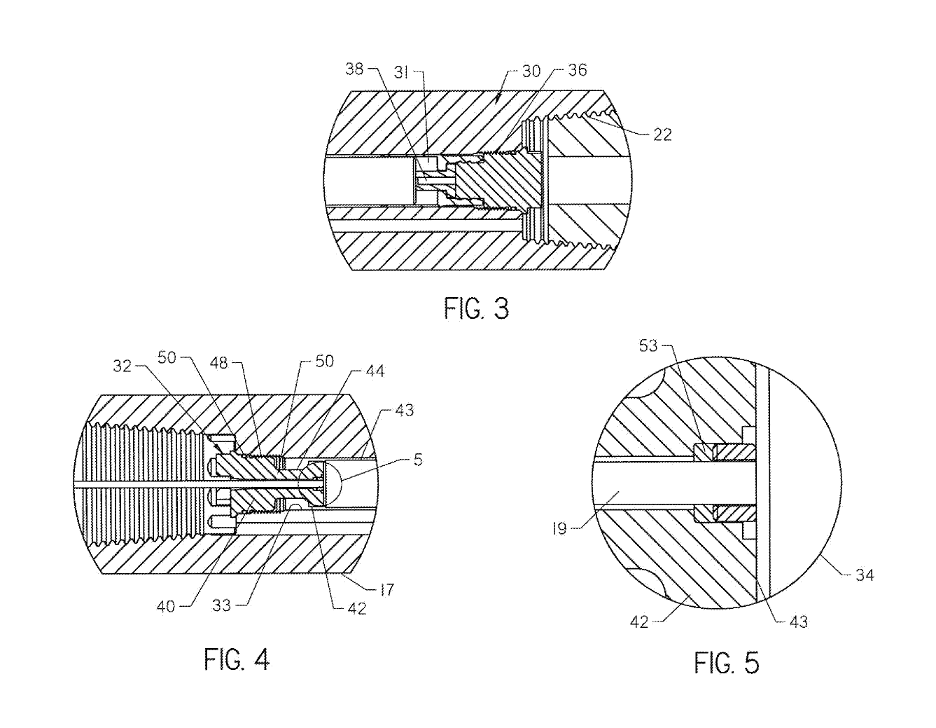

The bit adapter 20 may comprise threads 22, shown more clearly in FIG. 3, at its up hole end for connecting the bit adaptor to the housing 17. The bit adapter 20 has a central fluid passage 24 and a discharge nozzle 26 to meter drilling fluid or mud from the downhole end of the adaptor 20. Alternatively, one skilled in the art will appreciate passage 24 may be operatively connected to a fluid passage formed in the drill bit 12 such that said fluid is expelled from the bit itself. Both the bit adapter 20 and housing 17 are preferably made of a non-magnetic metal (steel) for use in the present invention.

Continuing with FIG. 2-5, the housing 17 has at least one fluid passage 28 that direct the drill fluid or mud along the housing 17 to the bit adaptor 20 and around the cavity 18. One such passage 28 is shown below the cavity 18 in FIG. 2. One skilled in the art will appreciate that a plurality of passages may be disposed about the housing without departing from the spirit of the present invention. Such passages may be arranged in a circular formation around the periphery of the cavity 18.

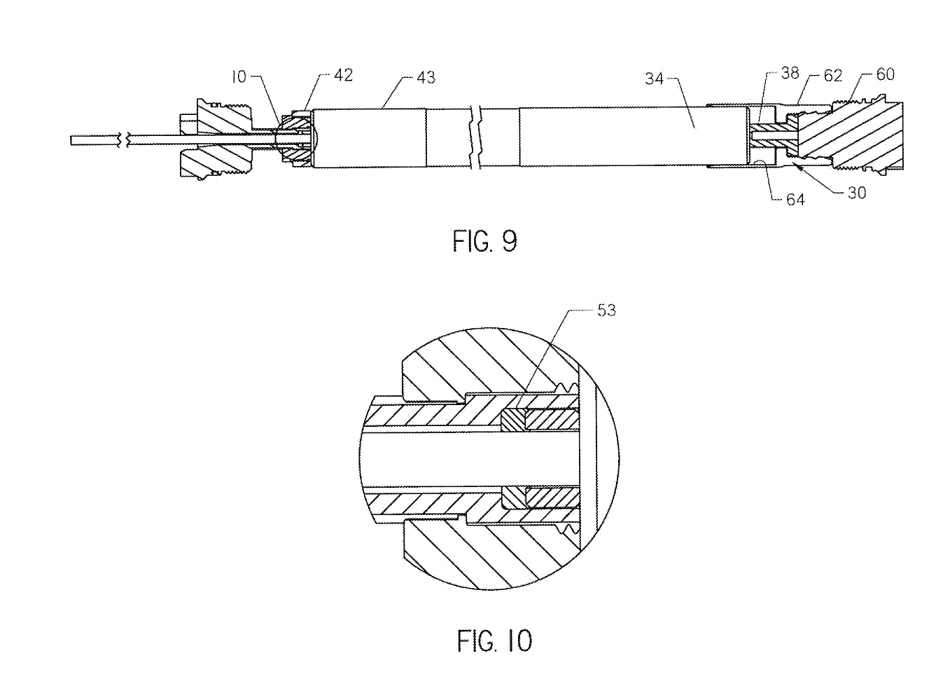

Cavity 18 is sealed from the flow of pressurized mud via a front plug 30 and a rear end cap 32. The front plug 30 attaches to the front end opening 31 of the cavity 18 and encloses the front end opening. The rear end cap is securable within the rear end opening 33 of the cavity 18. A sonde 34 is disposed within the cavity 18 and engages the front plug 30 and the rear end cap 32 at opposite ends. The sonde 34 comprises a sensor (not shown) and a transmitter (not shown) connected to the sensor. The sonde 34 may be formed inside of a non-magnetic tube 43. The transmitter may comprise a radio signal transmitter adapted to transmit a directional signal based on a sensor output. The front plug 30, shown more clearly in FIG. 3, comprises an O-ring 36 and an elastic isolator 38 to help seal and cushion the sonde 34 from shock. As shown in FIG. 9, the end plug comprises a non-ferrous component having a series of threads 60 for threading the plug into the cavity 18 of the housing 17. An elastic isolator 38 is positioned between the sonde 34 and the plug 30 to absorb shock during drilling operations. A sleeve 62 is formed to support the isolator 38, plug 30 and sonde 34. The sleeve 62 comprises a cavity 64 formed to support the sonde 34 therein.

The sensor may comprise an orientation sensor package adapted to detect the roll, pitch and/or yaw orientation of the sonde assembly. Accordingly, the sensor may comprise a sensor that senses the magnetic field of the earth such as a magnetometer. The sensor may alternatively comprise at least one accelerometer. The sensor generates an output signal indicative of an orientation component of the sonde 34 and housing 17 and transmits said output to the transmitter. The transmitter, in turn, embeds or encodes orientation information onto a communication signal that is transmitted above-ground.

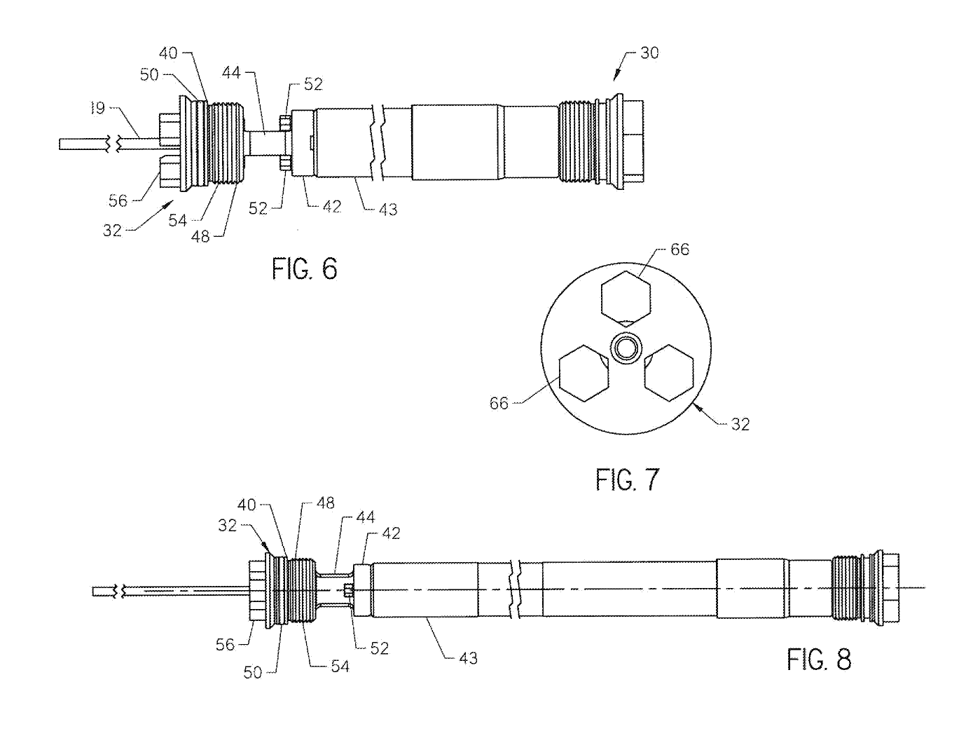

Referring now to FIGS. 6-9 in addition to FIGS. 2-5, the rear end cap 32 is securable in a fixed position in the rear end opening 33 (FIG. 4) of the cavity 18. The rear end cap 32 comprises a rear plug 40, a flange 42, and a connector 44. The rear plug 40 extends into the cavity 18 and creates a tight seal via threads 48 and an O-ring 50 (FIG. 4) supported in an O-ring groove. The flange 42 is connected to the connector 44 and the sonde 34. The flange 42 has a hole (not shown) therein used to connect the flange to the tube 43. The non-magnetic tube 43 that houses the sensor and transmitter further comprises rearwardly opening holes (not shown) that align with the holes in the flange 42. At least two bolts 52 (FIGS. 6 & 8) are used to secure the rear end cap 32 to the non-magnetic tube 43. The bolts 52 are preferably located 180 degrees apart. Connection of the flange 42 to the non-magnetic tube 43 may seal the sonde 34 to prevent pressurized fluid from entering the sonde. FIGS. 5 and 10 show the flange 42 connected to the tube 43. As bolts 52 are tightened to bias the flange 42 toward the tube 43, an O-ring 53 compressed to seal the sonde where the wireline 19 enters the sonde tube 43.

The attachment of the rear end cap 32 to the sonde 34 and cavity 18 is considered a semi-permanent installation, removable to service the cavity 18, sonde 34, or front plug 30. The front plug 30 and rear plug 40 also seal a data transmission line wireline 19 (FIG. 5) which extends from the rear of the sonde 34 and continues through the length of the drill stem up to the machine (not shown). The data transmission line 19 works to transmit the directional signal and other information from the sonde 34 up to the operator regarding the position, operation, and condition of the sonde assembly 100.

FIGS. 6-9 show the sonde 34 with front plug 30 and rear end cap 32 connected on opposite ends. As shown in FIGS. 2-4, the sonde 34 is secured within the housing 17 using front plug 30, and rear end cap 32 via threads. The rear end cap 32 is attached to the housing via threads 48. As shown in FIG. 7, the rear end cap 32 comprises three geometric shaped holes 66 adapted to receive a correspondingly formed geometric tool used to rotate the rear end cap 32 to thread it into the cavity 18 to isolate the sonde 34 from the flow of fluid through the housing 17.

The front plug 30 remains in place sealing the front end opening 31 of the cavity 18 while the rear end cap 32 seals the rear end opening 33 of the cavity 18 and secures the sonde 34 in place within the non-magnetic housing 17. By this means the sonde 34, housing 17, front plug 30, and rear end cap 32, rotate as a unit.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims.

What is claimed is:

1. A sonde assembly, comprising:
a sonde housing comprising a non-magnetic tube having a cavity;
a front plug for enclosing a front end opening of the cavity;
a sonde disposed within the cavity, the sonde comprising a sensor and a transmitter connected to the sensor to transmit a directional signal based on a sensor output; and
a rear end cap securable in a rear end opening of the cavity;
wherein the rear end cap and the front plug secure the sonde in a fixed position relative to the sonde housing.

2. The assembly of claim 1, wherein the sensor senses the magnetic field of the earth.

3. The assembly of claim 1, wherein the rear end cap further comprises a rear plug forwardly extending into the cavity.

4. The assembly of claim 3, wherein the rear end cap further comprises a connector and a large diameter portion, the connector rigidly connecting the rear plug to the larger diameter portion of the rear end cap.

5. The assembly of claim 3, wherein the rear plug further comprises a front end flange having holes there through, the non-magnetic tube having rearwardly opening holes therein alignable with the holes in the flange of the rear plug, and fasteners disposed within the holes of the front end flange and the rearwardly opening holes to secure the rear end cap to the non-magnetic tube.

6. The assembly of claim 1, wherein the front plug is securable in a fixed position in a front end opening of the cavity.

7. The assembly of claim 1, wherein the non-magnetic tube comprises a non-magnetic stainless steel.

8. The assembly of claim 1, wherein the non-magnetic tube further comprises windows therein to permit the directional signal to be transmitted from inside the non-magnetic tube.

9. A sonde assembly, comprising:
a sonde housing comprising a non-magnetic tube; the tube having a cavity, the tube having a front end opening and a rear end opening;
a means for enclosing the front end opening;
a sonde disposed within the cavity, the sonde comprising a sensor and transmitter connected to the sensor to transmit a directional signal based on a sensor output; and
a means for enclosing the rear end opening and securing the sonde within the cavity in a fixed position relative to the sonde housing.

10. The assembly of claim 9, wherein the sensor senses the magnetic field of the earth.

11. The assembly of claim 9, wherein the means for enclosing the front end opening comprises a front plug.

12. The assembly of claim 9, wherein the means for enclosing the rear end opening comprises a rear end cap.

13. The assembly of claim 12, wherein the rear end cap comprises a rear plug, a connector, and a large diameter portion, the connector connecting the rear plug to the large diameter portion.

14. The assembly of claim 9, wherein the non-magnetic tube comprises a non-magnetic stainless steel.

15. The assembly of claim 9, wherein the non-magnetic tube comprises windows therein to permit the directional signal to be transmitted from inside the non-magnetic tube.

16. A sonde assembly, comprising:
a sonde housing comprising a non-magnetic tube having a front end opening and a rear end opening;
a front plug for enclosing the front end opening of the non-magnetic tube;
a sonde disposed inside the non-magnetic tube; and
a rear end cap securable in a fixed position in the rear end opening of the non-magnetic tube.

17. The sonde assembly of claim 16, wherein the sonde comprises a non-magnetic cylinder and a sensor and a transmitter disposed within the non-magnetic cylinder, wherein the sensor and transmitter are connected for the transmitter to transmit a directional signal based on a sensor output.

18. The sonde assembly of claim 16, wherein securing the rear end cap in the rear end opening of the sonde assembly secures the sonde in a fixed position relative to the sonde housing.

19. The sonde assembly of claim 16, wherein the sensor senses the magnetic field of the earth.

20. The sonde assembly of claim 16, wherein the non-magnetic tube comprises a non-magnetic stainless steel.

21. The sonde assembly of claim 16, wherein the non-magnetic tube further comprises windows therein to permit the directional signal to be transmitted from inside the non-magnetic tube.

22. The sonde assembly of claim 16, wherein the rear end cap comprises a rear plug, a connector, and a larger diameter portion.
